(19) United States
(12) Patent Application Publication
(10) Pub. No.: US 2015/0219826 A1
(43) Pub. Date: Aug. 6, 2015

(54) DISPLAY DEVICE

(71) Applicant: InnoLux Corporation, Miao-Li County (TW)

(72) Inventors: Chin-Lung TING, Miao-Li County (TW); Li-Wei MAO, Miao-Li County (TW); Chia-Liang HUNG, Miao-Li County (TW)

(21) Appl. No.: 14/593,147

(22) Filed: Jan. 9, 2015

(30) Foreign Application Priority Data
Feb. 5, 2014 (TW) 103106254

(51) Int. Cl. F21V 8/00; G02B 27/22

(52) U.S. Cl. CPC G02B 6/0038; G02B 27/22

(57) ABSTRACT

A display device is provided, which comprises: a display panel comprising a substrate; and a light guide plate disposed on a light incident side of the display panel, wherein a difference between expansion ratios of the substrate and the light guide plate is in a range from 0% to 0.5% when a temperature of the display panel is between 0° C. and 150° C. In addition, the display device of the present invention can further comprise: a light source disposed at a side of the light guide plate.

### CROSS REFERENCE TO RELATED APPLICATION

This application claims the benefits of the Taiwan Patent Application Serial Number 103106254, filed on Feb. 5, 2014, the subject matter of which is incorporated herein by reference.

### BACKGROUND OF THE INVENTION

1. Field of the Invention

The present invention relates to a display device and, more particularly, to a display device that a light guide plate and a display panel have similar expansion ratios.

2. Description of Related Art

As the electronic products progressed, the demands for the same are also increased. For display devices, display quality thereof is one item that consumers request. Backlight modules are one essential unit in the display devices, and the efficiency thereof is also one factor related to the display quality of the display device. In general, the backlight module is assembled with a rear frame, a light guide plate, a light source and plural optical films, and provides light into the display panel.

The conventional light guide plate is made of polymers, which have relative high thermal expansion coefficients and moisture absorption rates. Hence, during the operation of the display device, the heat generated from the display panel may cause the display panel expanded, resulting in a relative shift between the light guide plate and the display panel. Especially, the relative shift therebetween is more significant in a 3D display device.

In addition, for the purpose of improved display qualities of the display devices and enhanced light extracting rates of the light source, the light guide plate made of the polymers cannot exhibit desired light transmission, and thus partial light emitting from the light source may be lost, resulting in the brightness of the display panel reduced.

Therefore, it is desirable to provide a novel light guide plate, which has similar expansion ratio to the display panel and even has high light transmittance to improve the display quality of the applied display device.

### SUMMARY OF THE INVENTION

An object of the present invention is to provide a display device, wherein an expansion ratio of a light guide plate is similar to that of a substrate of a display panel, so that a relative shift between the light guide plate and the display panel can be reduced.

Another object of the present invention is to provide a method for manufacturing a light guide plate, wherein a roughness of a side of the light guide plate is reduced to improve an incident ratio of light emitting from a side-emitting light source.

To achieve the object, the display device of the present invention comprises: a display panel comprising a substrate; and a light guide plate disposed on a light incident side of the display panel, wherein a difference between expansion ratios of the substrate and the light guide plate is in a range from 0% to 0.5% when a temperature of the display panel is between 0° C. and 150° C.

In addition, the present invention further provides another display device, which comprises: a display panel comprising a substrate; a light guide plate disposed on a light incident side of the display panel; and a light source disposed at a side of the light guide plate, wherein a difference between expansion ratios of the substrate and the light guide plate is in a range from 0% to 0.5% when a temperature of the display panel is between 0° C. and 150° C.

In the display device of the present invention, the difference between the expansion ratios of the substrate and the light guide plate is controlled in a specific range to reduce a relative shift between the light guide plate and the display panel. Specifically, when the display device of the present invention is applied to a three-dimensional (3D) display device, a relative shift between a pixel unit of a display panel and the light guide plate can be reduced due to the reduced relative shift between the display panel and the light guide plate, so that a cross-talk in 3D images caused by the aforementioned relative shift in the display device can be improved.

In the display device of the present invention, the expansion ratios of the substrate and the light guide plate are respectively in a range from 0% to 0.5% when a temperature of the display panel is between 0° C. and 150° C. More specifically, when a temperature of the display panel is between 0° C. and 150° C., thermal expansion coefficients of the substrate and the light guide plate are respectively in a range from 1×10⁻⁵ mm/° C. to 1×10⁻⁶mm/° C. In addition, when a temperature of the display panel is between 0° C. and 150° C., water absorption rates of the substrate and the light guide plate are respectively in a range from 0% to 0.28%. Preferably, the expansion ratio of the light guide plate is identical to that of the substrate. More preferably, a material of the light guide plate is identical to that of the substrate. Most preferably, both the materials of the light guide plate and the substrate are glass.

In addition, the method for manufacturing a light guide plate of the present invention comprises the following steps: providing a light guide mother plate; grinding a side of the light guide mother plate; and coating the ground side thereof with light guide glue and curing the light guide glue to obtain the light guide plate of the present invention. After the obtained light guide plate is assembled with a display panel, the display device of the present invention is obtained. Hence, in the display device of the present invention, the light guide glue is disposed on a side of the light guide plate. In addition, the display device of the present invention may further comprise a light source corresponding to the light guide glue. Herein, a material of the light guide glue can be glue having similar refractive index to the light guide plate. Preferably, the refractive index of the light guide glue is in a range from 1 to 1.7.

In the present invention, the aforementioned display device can be a two-dimensional (2D) display device or a 3D display device.

When the display device of the present invention is a 3D display device, the light guide plate has a first surface and a second surface opposite to the first surface. The display panel is disposed on the first surface of the light guide plate, and a scattering pattern having plural stripes is disposed on the second surface thereof. In addition, the display panel may comprise a pixel unit comprising plural subpixel units. Herein, a gap between two adjacent stripes of the scattering pattern is an integer multiple of a width of the subpixel unit. Meanwhile, widths of the stripes of the scattering pattern are respectively identical to those of the subpixel unit.

Other objects, advantages, and novel features of the invention will become more apparent from the following detailed description when taken in conjunction with the accompanying drawings.

### BRIEF DESCRIPTION OF THE DRAWINGS

FIGS. 1A and 1B are perspective views showing a light guide mother plate and a scattering pattern having plural stripes formed thereon according to Embodiment 1 of the present invention;

FIG. 2 is a perspective view showing a polishing process performed on a light guide mother plate according to Embodiment 1 of the present invention;

FIG. 3 is a perspective view showing a glue dispensing process performed on a light guide mother plate according to Embodiment 1 of the present invention;

FIGS. 4 and 5 are cross-sectional view showing partial light guide plate according to other embodiments of the present invention;

FIG. 6 is a perspective view showing a backlight module according to Embodiment 1 of the present invention;

FIG. 7 is a perspective view showing a 3D display device according to Embodiment 1 of the present invention; and

FIG. 8 is a perspective view showing a 2D display device according to Embodiment 2 of the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1

### 3D Display Device

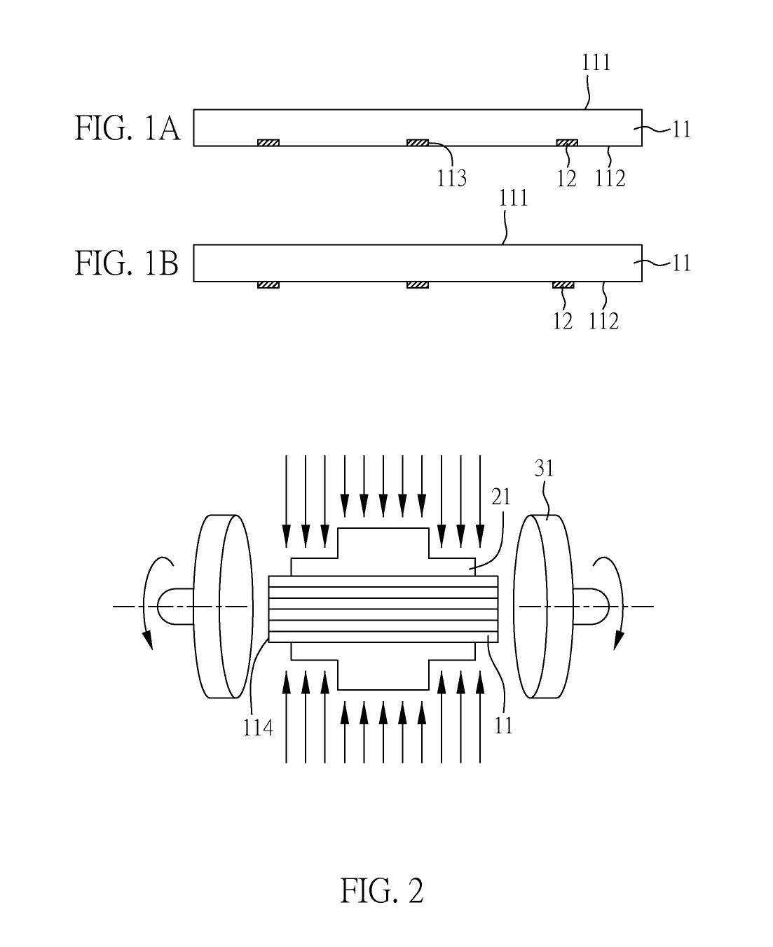

As shown in FIG. 1A, a light guide mother plate 11 is firstly provided, which is a glass substrate. The light guide mother plate 11 has a first surface 111 and a second surface 112 opposite thereto, and a scattering pattern having plural stripes 12 is further disposed on the second surface 112. Herein, each stripe 12 of the scattering pattern is embedded into a cavity 113 of the light guide mother plate 11. However, in other embodiment, the stripes 12 of the scattering pattern may be directly disposed on the second surface 112 of the light guide mother plate 11, as shown in FIG. 1B.

In the present embodiment, the material for forming the scattering pattern having plural stripes 12 is not particularly limited, and can be any material capable of reducing total reflection. For example, the material for forming the scattering pattern having plural stripes 12 can be a composite material of TiO₂ and ink (or resin). However, the present invention is not limited thereto.

FIG. 2 is a perspective view showing a polishing process performed on a light guide mother plate of the present embodiment, in which the scattering pattern having plural stripes 12 of FIGS. 1A and 1B are not shown. As shown in FIG. 2, the light guide mother plates 11 are placed between two clamping units 21, a proper pressure (indicated by arrows) is performed thereon, and sides 114 of the light guide mother plates 11 are polished with polishing wheels 31 to perform the polishing process. During the polishing process performed on the sides 114 of the light guide mother plates 11, grinding wheels with various roughness can be selectively used to make the sides 114 thereof more even. Herein, metal grinding wheels are used as the polishing wheels 31 to grind the sides 114 of the light guide mother plates 11, and then fine resin grinding wheels are used to grind the sides 114 thereof to make the sides 114 thereof more even. However, in other embodiments, grinding wheels made of different materials or several grinding wheels can be used to perform the polishing process.

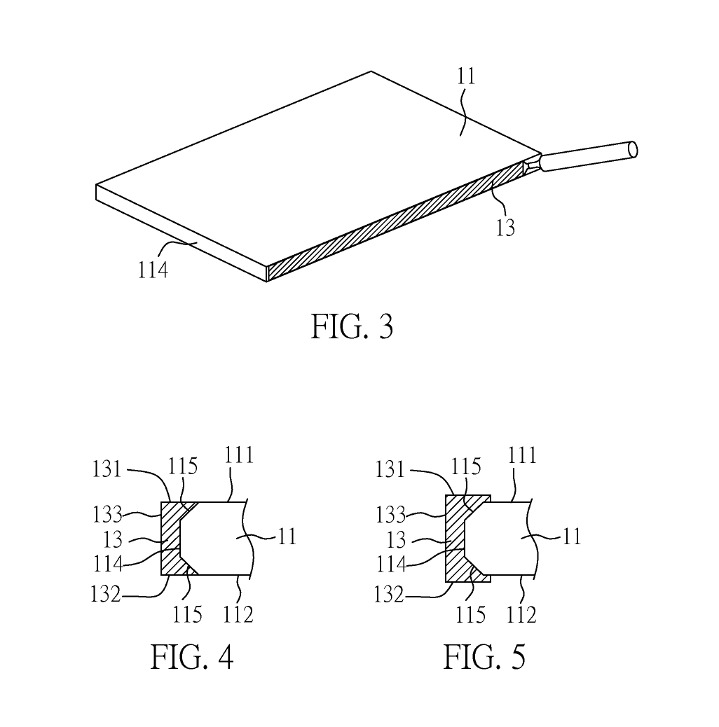

In the present embodiment, in order to improve the evenness of the sides 114 of the light guide mother plates 11, the sides 114 thereof are coated with light guide glue 13, as shown in FIG. 3. In the present embodiment, the light guide glue 13 can be a thermal curing resin or a photo curing resin (such as UV resin), as long as a refractive index of the light guide glue 13 after curing is closed to that of the light guide mother plates 11. In the present embodiment, the light guide mother plate 11 is a glass substrate, which has a refractive index about 1.5. In addition, a refractive index of the light guide glue 13 can be in a range from 1 to 1.7, preferably in a range from 1.3 to 1.6, and more preferably in a range from 1.4 to 1.6.

After the coated light guide glue 13 is molded and cured, a light guide plate of the present embodiment is obtained. The roughness of the sides 114 of the original light guide mother plates 11 can be improved by the coated light guide glue 13. In other words, the roughness of the sides 114 thereof after applying the light guide glue 13 is smaller than that before applying the light guide glue 13, so the surface of the obtained light guide plate is more even. In addition, when the refractive index of the cured light guide glue 13 is properly selected, the light coupling efficiency of the light guide plate in which the light irradiates into the sides thereof can further be improved.

In the light guide mother plates 11 shown in FIGS. 1A, 1B and 3, the light guide mother plates 11 are plates without chamfering angles. However, in other embodiments, the light guide mother plates 11 may have chamfering angles, as shown in FIGS. 4 and 5. When inclined surfaces 115 are located between the side 114 and the first surface 111/the second surface 112 of the light guide mother plate 11, the light guide glue 13 may simultaneously cover the inclined surfaces 115. In addition, an upper surface 131 of the light guide glue 13 and the first surface 111 may be substantially in the same plane as well as a lower surface 132 thereof and the second surface 112 may also be substantially in the same plane, as shown in FIG. 4. Alternatively, the light guide glue 13 may partially cover the first surface 111 and the second surface 112, as shown in FIG. 5. Meanwhile, in both the aspects shown in FIGS. 4 and 5, a side surface 133 of the light guide glue 13 is substantially vertical to the upper surface 131 and the lower surface 132 thereof.

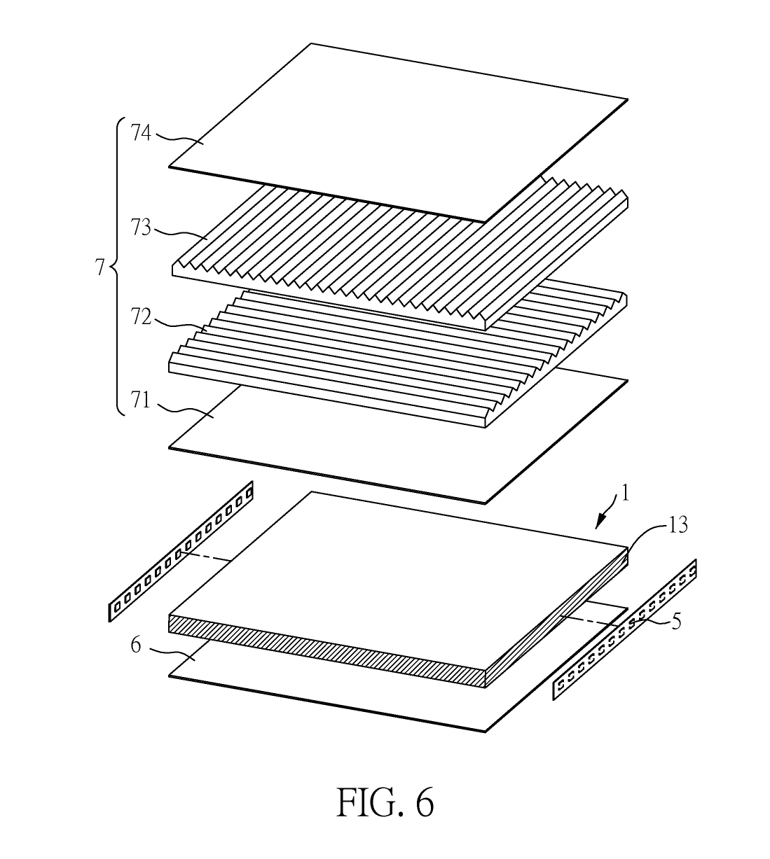

FIG. 6 is a perspective view showing a backlight module with the aforementioned light guide plate of the present embodiment. Herein, the light guide plate 1 is disposed on a rare frame 6, and a light source 5 is disposed near the light guide glue 13. Herein, the light guide glue 13 is disposed around all the four sides 114 of the light guide mother plate 11, as shown in FIGS. 3 and 6. However, in other embodiment, the light guide glue 13 can be only disposed at a side corresponding to the light source 5, i.e. the light guide glue 13 is only disposed at the light incident side of the light guide plate 1. In the present embodiment, the light source 5 comprises plural LEDs, but the present invention is not limited thereto. In addition, at least one optical film 7 is further disposed on the light guide plate 1, and the optical film 7 comprises a diffusion layer 71, a first prism layer 72, a second prism layer 73 and another diffusion layer 74 sequentially formed on the light guide plate 1. After a display panel (not shown in the figure) is placed on the optical film 7, the display device of the present embodiment is obtained.

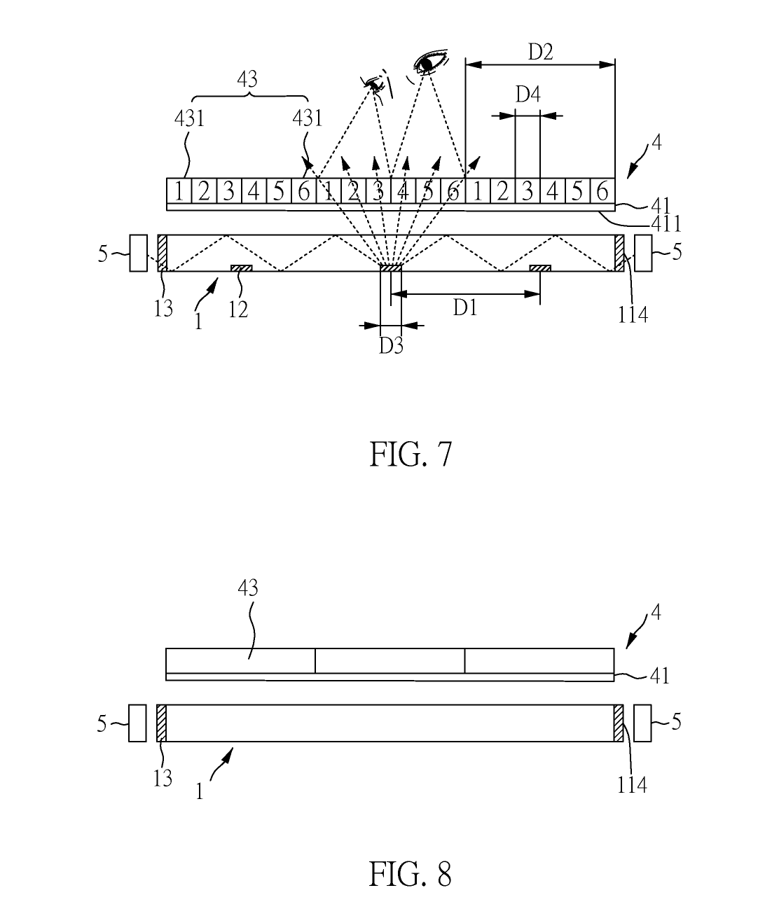

FIG. 7 is a perspective view showing a 3D display device of the present invention, in which the rare frame 6 and the optical film 7 shown in FIG. 6 are not illustrated in FIG. 7. As shown in FIG. 7, the display device of the present embodiment comprises: a display panel 4 comprising a substrate 41; a light guide plate 1 disposed on a light incident side 411 of the display panel 4; and light sources 5 disposed at the sides 114 of the light guide plate 1. Herein, the light guide glue 13 is disposed on the sides 114 of the light guide plate 1, and the light sources 5 correspond to the light guide glue 13. FIG. 7 shows a 3D display device equipped with the light guide plate prepared from the light guide mother plate shown in FIG. 1A. In other embodiment, the 3D display device may be equipped with the light guide plate prepared from the light guide mother plate shown in FIG. 1B.

As shown in FIG. 7, the display panel 4 of the 3D display device of the present embodiment comprises a pixel unit 43, which comprises plural subpixel units 431. Herein, a pixel unit 43 comprising six subpixel units 431 is exemplified. However, in other embodiment, the purpose of exhibiting 3D images can be obtained by using 3D display device equipped with a pixel unit 43 comprising at least two subpixel units 431.

The sides 114 of the light guide plate 1 become more even due to the disposition of the light guide glue 13, so that the light coupling efficiency of the light guide plate in which the light irradiates into the sides thereof can further be improved when light of the light sources 5 irradiates into the light guide plate 1. In addition, the light emitted from the light sources 5 can totally reflect in the light guide plate 1. Furthermore, when the light irradiates onto the stripes 12 of the scattering pattern, the scattered light can pass through different subpixel units 431. In this case, an observer can simultaneously observe light emitted from different subpixel units 431. For example, after the light emitted from the left light source 5 irradiates onto the stripes 12 of the scattering pattern through total reflection, the scattered light passing through the subpixel unit 431 indicated by “1” can irradiate into a left eye of the observer. Meanwhile, after the light emitted from the right light source 5 irradiates onto the stripes 12 of the scattering pattern through total reflection, the scattered light passing through the subpixel unit 431 indicated by “6” can irradiate into a right eye of the observer. Since the left and right eyes of the observer can simultaneously observe the light passing through different subpixel units 431, the purpose of displaying 3D images can be achieved. In addition, since the scattering pattern having stripes 12 are disposed on the light guide plate 1, the light can be distributed out in parallax that bright and dark light are arranged alternately. Hence, the observer can observe 3D images when the light scattered by the light guide plate 1 passes through the display panel.

During the operation of the 3D display device, both the display panel 4 and the light guide plate 1 may expand. If the difference between expansion ratios of the display panel 4 and the light guide plate 1 are too large, a relative shift may be occurred between the subpixel units 431 and the stripes 12 of the scattering pattern, resulting in a cross-talk effect. In the 3D display device of the present embodiment, the substrate 41 of the display panel 4 is a glass substrate. Since both the substrate 41 of the display panel 4 and the light guide plate 1 are glass substrates, the display panel 4 and the light guide plate 1 have identical expansion ratios. Thus, the aforementioned problem of the cross-talk effect can be solved to improve the display quality of 3D images. Moreover, the light guide plate 1 made of glass have better light transmission compared to the conventional light guide plate made of polymers, so the display device equipped with the light guide plate 1 of the present embodiment can exhibit better brightness. In addition, the light guide plate 1 made of glass can be applied to the currently used process for manufacturing thin film transistor units.

However, in other embodiment, the substrate 41 of the display panel 4 and the light guide plate 1 can be made of other materials other than glass, as long as a difference between expansion ratios of the substrate 41 and the light guide plate 1 is in a range from 0% to 0.5% when a temperature of the display panel is between 0° C. and 150° C. Preferably, the difference therebetween is in a range from 0% to 0.35%. More preferably, the difference therebetween is in a range from 0% to 0.25%. Further preferably, the difference therebetween is in a range from 0% to 0.1%. Most preferably, the expansion ratio of the light guide plate 1 is identical to that of the substrate 41. In order to obtain the purpose that the expansion ratio of the light guide plate 1 is identical to that of the substrate 41, both the substrate 41 and the light guide plate 1 are made of the same material such as glass. In the present invention, a difference between expansion ratios of the substrate 41 and the light guide plate 1 is defined as follows.
Term A: A length of the substrate 41 of the display panel 4 is x, and that of the light guide plate 1 is y.
Term B: A length of the substrate 41 of the display panel 4 is x′, and that of the light guide plate 1 is y′.
Difference between expansion ratios=|(x′/x)−(y′/y)|
Herein, Terms A and B can be defined under a temperature between 0° C. and 150° C. When Terms A and B are measured at different temperatures, the difference between expansion ratios indicates the difference between thermal expansion coefficients.

More specifically, the difference between expansion ratios of the substrate 41 and the light guide plate 1 is in a range from 0% to 0.5% when a temperature of the display panel is between 0° C. and 150° C. Preferably, the difference therebetween is in a range from 0% to 0.35%. More preferably, the difference therebetween is in a range from 0% to 0.25%. Further preferably, the difference therebetween is in a range from 0% to 0.1%. The problem that a relative shift is occurred between the conventional light guide plate made of polymers and the substrate (especially, the glass substrate) of the display panel can be solved by using the light guide plate with the aforementioned features of the present invention. Thus, the display quality of 3D images can further be improved.

In addition, in the present embodiment, when a temperature of the display panel is between 0° C. and 150° C., a thermal expansion coefficients of the light guide plate and the substrate of the display panel can respectively be in a range from 1×10⁻⁵ mm/° C. to 1×10⁻⁶ mm/° C.; and preferably 1×10⁻⁵ mm/° C. to 8×10⁻⁶ mm/° C. Furthermore, when a temperature of the display panel is between 0° C. and 150° C., a moisture absorption rates of the light guide plate and the substrate of the display panel can respectively be in a range from 0% to 0.28%; preferably 0% to 0.1%; and most preferably closed to 0%. Hence, compared to the conventional light guide plate made of polymers, the purpose that the substrate of the display panel and the light guide plate have similar expansion ratios can be obtained by using the light guide plate of the present invention.

Furthermore, as shown in FIG. 7, a gap D1 between two adjacent stripes 12 of the scattering pattern is an integer multiple of a width D4 of the subpixel unit 431. In the present embodiment, a gap D1 between two adjacent stripes 12 of the scattering pattern is identical to the width D2 of the pixel unit 43. In addition, a width D3 of the stripe 12 of the scattering pattern is closed or even identical to the width D4 of the subpixel unit 431. When the display device has the aforementioned features, the purpose of displaying 3D images can be achieved.

### Embodiment 2

### 2D Display Device

The light guide plate of Embodiment 1 can also be applied to the 2D display device of the present embodiment, except the following differences.

The 2D display device of the present embodiment is not equipped with the stripes of the scattering pattern of Embodiment 1, but with a dot pattern (not shown in the figure) on the second surface 112 of the light guide plate 1. Meanwhile, the pixel unit 43 of the display panel 4 cannot be composed of plural subpixel units.

Herein, the light guide plate of the present embodiment has the same features as those illustrated in Embodiment 1.

Furthermore, the aforementioned display device illustrated in Embodiments 1 and 2 are not particularly limited, and can be any liquid crystal display panels used in the art. In addition, the display device provided by the present invention can be applied to any electronic device for displaying images, such as a mobile phone, a notebook, a camera, a video camera, a music player, a navigation system, or a television.

Although the present invention has been explained in relation to its preferred embodiment, it is to be understood that many other possible modifications and variations can be made without departing from the spirit and scope of the invention as hereinafter claimed.

What is claimed is:

1. A display device, comprising:
a display panel comprising a substrate; and
a light guide plate disposed on a light incident side of the display panel,
wherein a difference between expansion ratios of the substrate and the light guide plate is in a range from 0% to 0.5% when a temperature of the display panel is between 0° C. and 150° C.

2. The display device as claimed in claim 1, wherein the expansion ratios of the substrate and the light guide plate are respectively in a range from 0% to 0.5%.

3. The display device as claimed in claim 1, wherein the expansion ratio of the light guide plate is identical to that of the substrate.

4. The display device as claimed in claim 1, wherein a material of the light guide plate is identical to that of the substrate.

5. The display device as claimed in claim 1, wherein light guide glue is disposed on a side of the light guide plate.

6. The display device as claimed in claim 5, wherein a refractive index of the light guide glue is in a range from 1 to 1.7.

7. The display device as claimed in claim 1, wherein a scattering pattern having plural stripes is disposed on the light guide plate.

8. The display device as claimed in claim 7, wherein the display panel comprises a pixel unit comprising plural subpixel units, wherein a gap between two adjacent stripes of the scattering pattern is an integer multiple of a width of the subpixel unit.

9. The display device as claimed in claim 8, wherein widths of the stripes of the scattering pattern are respectively identical to those of the subpixel unit.

10. A display device, comprising:
a display panel comprising a substrate;
a light guide plate disposed on a light incident side of the display panel; and
a light source disposed at a side of the light guide plate,
wherein a difference between expansion ratios of the substrate and the light guide plate is in a range from 0% to 0.5% when a temperature of the display panel is between 0° C. and 150° C.
